(19) United States
(12) Patent Application Publication
(10) Pub. No.: US 2008/0317165 A1
(43) Pub. Date: Dec. 25, 2008

(54) Systems and methods of calibrating a transmitter

(75) Inventors: Mahdi Bagheri, Los Angeles, CA (US); Rahim Bagheri, Los Angeles, CA (US); Saeed Chehrazi, Los Angeles, CA (US); Masoud Djafari, Marina Del Rey, CA (US); Hassan Maarefi, Los Angeles, CA (US); Ahmad Mirzaei, Los Angeles, CA (US); Edris Rostami, Marina Del Rey, CA (US); Alireza Tarighat-Mehrabani, Los Angeles, CA (US)

Correspondence Address: Fountainhead Law Group P.C., Ste. 509, 900 Lafayette St, Santa Clara, CA, 95050, US

(73) Assignee: WiLinx Inc., Los Angeles, CA (US)

(21) Appl. No.: 11/820,671

(22) Filed: Jun. 19, 2007

(51) Int. Cl. H04L 25/03

(52) U.S. Cl. 375/296

(57) ABSTRACT

In one embodiment the present invention includes a method of calibrating the frequency response of a transmitter comprising generating a plurality of calibration tones across a frequency range, coupling the plurality of calibration tones to an input of said transmitter, detecting the plurality of calibration tones at an output in said transmitter, and in accordance therewith, generating a plurality of calibration values, receiving digital data to be transmitted, the digital data comprising a plurality of frequency components in said frequency range, and calibrating said frequency components of said digital data using the calibration values.

### BACKGROUND

The present invention relates to the transmission of signals, and in particular, to systems and methods of calibrating the response of a transmitter.

Unless otherwise indicated herein, the approaches described in this section are not prior art to the claims in this application and are not admitted to be prior art by inclusion in this section.

Communication systems generally contain one or more transmitters to transmit data from the transmitter to the receiver. The components included in a transmitter chain may vary depending on the attributes of the incoming signal and the goals of the transmitter. FIG. 1 illustrates a segment of a transmitter in a wireless communication system. Here, a digital-to-analog converter (“DAC”) 110 receives a digital input signal. The DAC converts a digital signal to an analog signal. This may be necessary in communication systems that take advantage of digital signal processing. The DAC is coupled to the input of filter 120. The filter may be used to clean up the signal by removing undesirable frequencies. The filter is then coupled to mixer 130. The mixer may be used to up-convert the frequency of the signal by combining it with a local oscillator signal (“LO”). The output of the mixer is coupled to power amplifier 140 to amplify the signal for transmission before it is sent through antenna 150. All the components described above may create distortion in the outgoing signal, thereby resulting in a frequency selective transmitter with a non-flat frequency response.

Wideband communication systems may create additional problems for the transmitter. For example, one advantage of wideband communication systems is its ability to support signals having multiple frequency components potentially using multiple carrier frequencies across a wide frequency range by increasing the bandwidth of the transmitter. As the frequency range is divided into many sub-bands, the transmitter may have different frequency response for these multiple bands. As a result, the frequency characterization of the transmitted signal over the entire bandwidth may no longer be flat. Also, continuous variations in power throughout the wide frequency bandwidth can be very challenging for the power amplifier to handle. Also, variations in power throughout the wide frequency may lower the total allowable transmit power specified by regulatory bodies or standardization committees. This is due to the fact that some of such restrictions, e.g. ultra wideband (UWB) regulations, impose a limit on the maximum power spectral density (psd or power/MHz) throughout the band of operation. Therefore, such variations can have two consequences: reduction in the total allowable transmit power, degradation in the quality of the transmitted signal or equivalently, the error-vector-magnitude (EVM). FIG. 2 illustrates a plot of frequency responses over a frequency range of interest. Here, frequency range of interest is f₁ to f₂. Frequency response 202 is an ideal response because its flat characteristic over the frequency range of interest may result in a higher quality transmission. Frequency response 201 may be the actual frequency response. The gain or attenuation of the transmitted signal as it travels through the transmitter is shown by the non-flat frequency response of the actual signal. Since flat frequency responses are desirable in a communication system as described earlier, significant deviations or ripples in the frequency response may introduce distortion to the transmitted signal. The result is that the transmission of the signal is suboptimum. Thus, there is a need for improved a method of transmitting signals across a transmitter. The present invention solves these and other problems by providing systems and methods of calibrating a transmitter.

### SUMMARY

Embodiments of the present invention improve calibration of a transmitter. In one embodiment the present invention includes a method of calibrating the frequency response of a transmitter comprising generating a plurality of calibration tones across a frequency range, coupling the plurality of calibration tones to an input of said transmitter, detecting the plurality of calibration tones at an output of said transmitter, and in accordance therewith, generating a plurality of calibration values, receiving digital data to be transmitted, the digital data comprising a plurality of frequency components in said frequency range, and calibrating said frequency components of said digital data using the calibration values.

In one embodiment, the plurality of calibration tones are at the same frequencies as the plurality of frequency components.

In one embodiment, the plurality of calibration tones are generated and detected serially.

In one embodiment, the plurality of calibration tones are generated and detected in parallel.

In one embodiment, calibrating said frequency components comprises multiplying the frequency components of the digital data by said calibration values.

In one embodiment, the present invention further comprises converting the frequency components into a time domain digital signal.

In one embodiment, calibrating said frequency components comprises changing the frequency response of a digital filter using the calibration values.

In one embodiment, calibrating said frequency components further comprises altering the frequency response of the frequency components of said digital data with the digital filter.

In one embodiment, detecting comprises detecting the amplitude of the calibration tones at the output of the transmitter.

In one embodiment, detecting comprises detecting the power of the calibration tones at the output of the transmitter.

In one embodiment, calibration tones are digital signals, and the digital signals are converted to analog signal by a digital-to-analog converter.

In one embodiment, the calibration values are equal to the inverse of the amplitudes of the calibration tones.

In one embodiment, the calibration values are equal to the amplitude of the calibration tone at the input of the transmitter divided by the amplitude of the calibration tone at the output of the transmitter.

In one embodiment, the transmitter is a wireless transmitter.

In another embodiment, the present invention includes a communication system comprising a calibration tone generator for generating a plurality of calibration tones across a frequency range, a transmitter coupled to receive said calibration tones, a detector coupled to an output of the transmitter, the detector generating a plurality of calibration values in response to the calibration tones at the output of the transmitter, and a frequency response calibration unit coupled to receive digital data to be transmitted and further coupled to receive the calibration values, the digital data comprising a plurality of frequency components in said frequency range, wherein the frequency response calibration unit calibrates said frequency components of said digital data using the calibration values.

In one embodiment, the calibration tones are transmitted serially.

In one embodiment, the calibration tones are transmitted in parallel.

In one embodiment, the calibration tones are the same amplitude.

In one embodiment, the calibration tones and the digital data contain the same frequency components.

In one embodiment, the plurality of calibration values are the inverse of the calibration tones at the output of the transmitter.

In one embodiment, the frequency response calibration unit comprises a programmable digital filter.

The following detailed description and accompanying drawings provide a better understanding of the nature and advantages of the present invention.

### BRIEF DESCRIPTION OF THE DRAWINGS

FIG. 1 illustrates a segment of a transmitter in a wideband communication system.

FIG. 2 illustrates an example plot of ideal and actual frequency responses over a frequency range.

FIG. 3A illustrates the frequency response of an example signal that has propagated through a transmitter without calibration.

FIG. 3B illustrates the frequency response of an example signal that has propagated through a transmitter with calibration according to one embodiment of the present invention.

FIG. 4 illustrates a communication system according to one embodiment of the present invention.

FIG. 5A illustrates an example of calibration tones at the input of the transmitter according to one embodiment of the present invention.

FIG. 5B illustrates an example frequency response of analog calibration signals at the output of the transmitter according to one embodiment of the present invention.

FIG. 5C illustrates an example of calibration tones at the output of the detector according to one embodiment of the present invention.

FIG. 5D illustrates an example of a digital data signal to be transmitted according to one embodiment of the present invention.

FIG. 5E illustrates an example of the digital data signal at the output of the frequency response calibration unit according to one embodiment of the present invention.

FIG. 5F illustrates an example of the frequency response of an analog signal at the output of the transmitter according to one embodiment of the present invention.

FIG. 6 illustrates a communication system according to one embodiment of the present invention.

FIG. 7 illustrates a frequency response calibration unit according to one embodiment of the present invention.

FIG. 8 illustrates a communication system using frequency response calibration unit according to another embodiment of the present invention.

FIG. 9 illustrates a method of calibrating a frequency response of a transmitter according to one embodiment of the present invention.

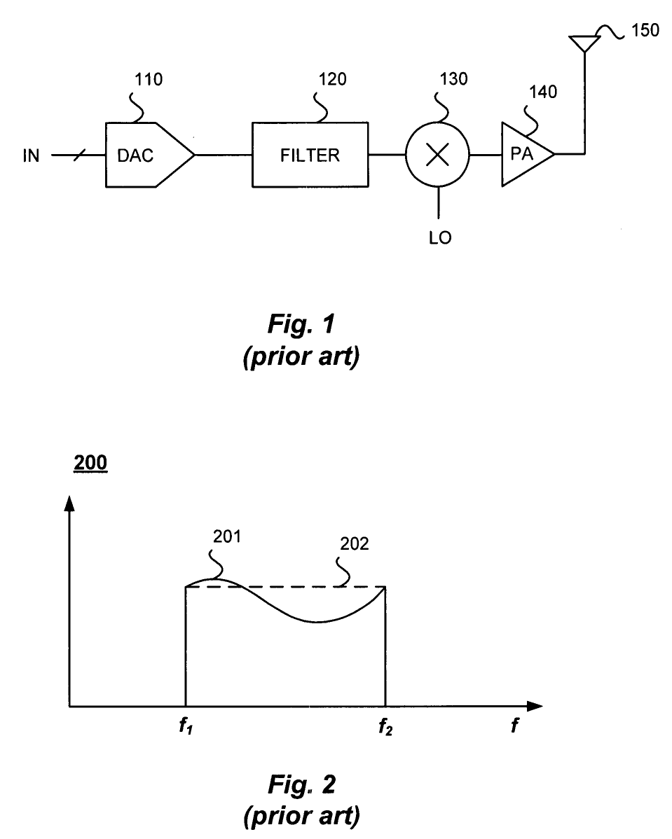

### DETAILED DESCRIPTION

Described herein are techniques for calibrating a transmitter. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

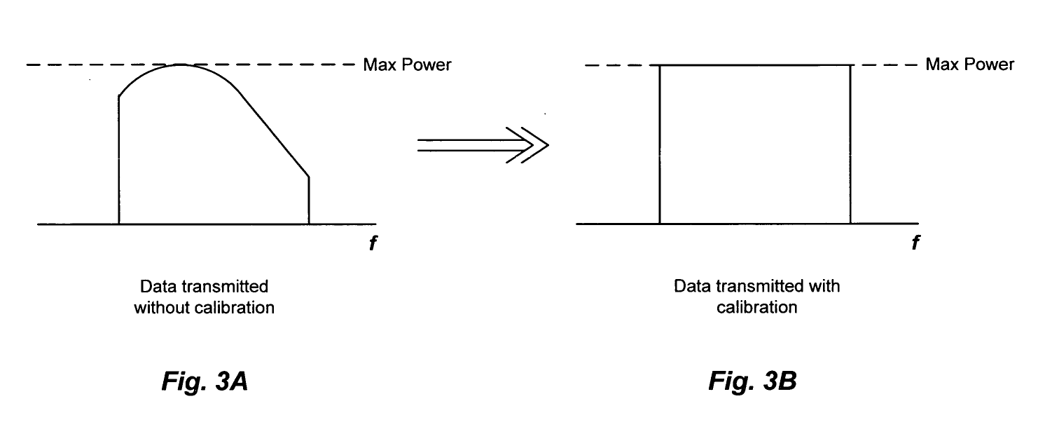

FIG. 3A illustrates the frequency response of a signal that has propagated through a transmitter without calibration. The frequency band here has not been fully utilized because a large portion of the frequency response is not at the maximum power level allowed by regulatory standards. This may be a common occurrence in ultra wide band communication systems where the frequency band is divided into multiple sub-bands. Problems associated with a non-flat frequency response may include reduction in the range of transmission, degradation in error vector magnitude (“EVM”) in standardized applications, and degradation in the final SNR at the receiver. If the problems are severe enough, data may be lost in the transmitted signal. FIG. 3B illustrates a signal that has propagated through a transmitter with calibration according to one embodiment of the present invention. As shown, the frequency response over the band of interest has been flattened, and may be aligned with the maximum power level, therefore minimizing the problems described above. This may result in a cleaner data transmission capable of traveling longer distances, for example.

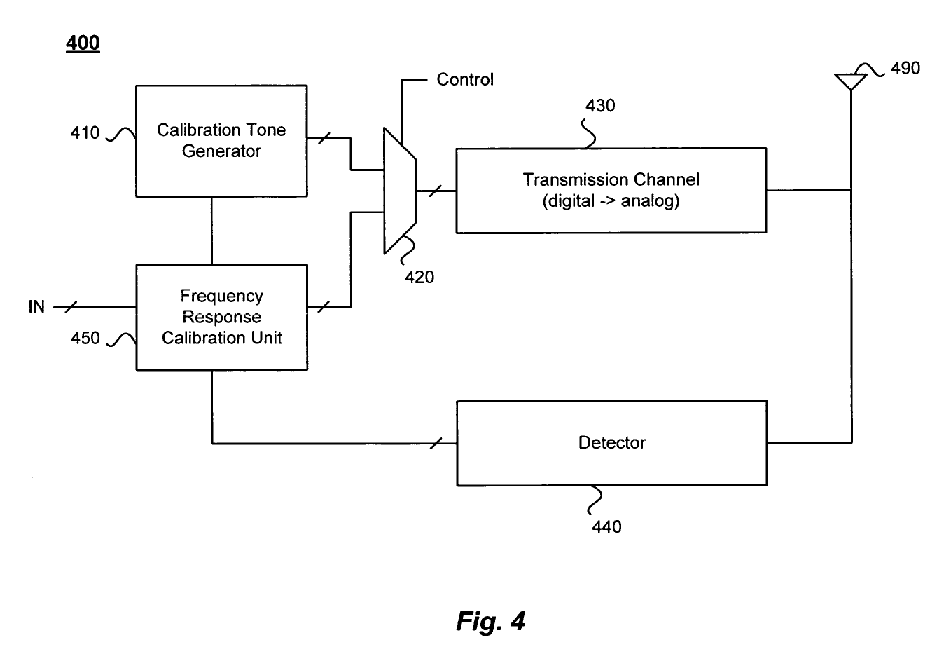

FIG. 4 illustrates a communication system according to one embodiment of the present invention. Communication system 400 may process a signal prior to transmission by calibrating it to compensate for expected distortion in the transmitter. This calibration begins by measuring and estimating the frequency-dependent response in the transmitter chain (due to analog lowpass filters, mixer/synthesizers, power-amplifier, antenna). This may be accomplished by sending sample tones (calibration tones) through the transmitter and measuring the distortion in these tones at the output of the transmitter. Calibration information may then be extrapolated from the sample tones at the output of the transmitter. This calibration information may be used to preprocess the signal to be transmitted, thereby compensating for the distortion that occurs as the signal travels through the transmitter. This may improve the flatness in the frequency response of the transmitted signal.

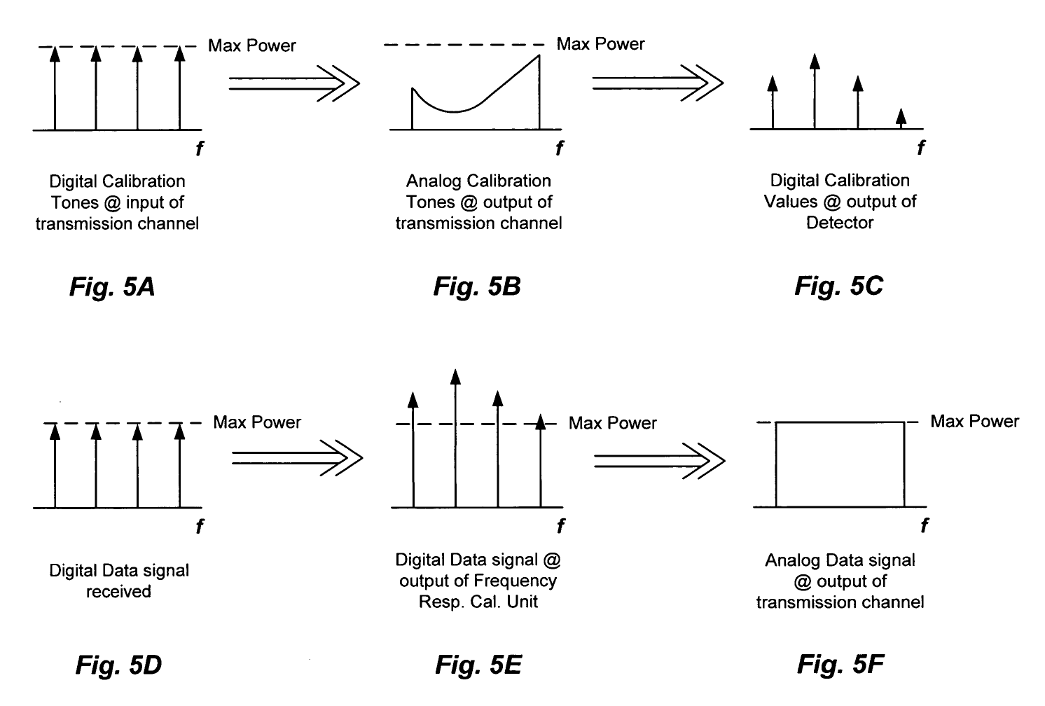

In this embodiment, calibration tone generator 410, multiplexer 420, transmitter 430, detector 440, and frequency response calibration unit 450 may be used to generate values that estimate and correct the distortion of transmitter 430 (which is due to the frequency-dependent response of the transmitter chain). These values are known as calibration values. Calibration values may be generated by sending calibration tones through the transmitter. These calibration tones are generated by calibration tone generator 410 prior to calibration of the input signal. Each calibration tone generated contains an amplitude and a frequency component. FIG. 5A illustrates an example of calibration tones at the input of the transmitter according to one embodiment of the present invention. In some embodiments, the calibration tones may be digital tones. In one example, the calibration tones all contain the same amplitude. In one example, the frequency components associated to the calibration tones are the same as the frequency components associated with the signal to be calibrated. Calibration tones may also be transmitted from the calibration tone generator in a variety of ways. In one example, the calibration tones are transmitted serially. This may result in a single calibration tone sent across the transmitter for each frequency of interest in a given frequency range. In another example, the calibration tones are transmitted in parallel. This may result in multiple calibration tones corresponding to the frequencies of interest to be transmitted through the transmitter concurrently as one signal. Disadvantages to parallel transmission may include an increase in complexity due to more hardware components.

Calibration tone generator 410 may be further coupled to the input of multiplexer 420, as shown in FIG. 4. Multiplexer 420 may control the data flow to the transmitter. Although a multiplexer is used in this embodiment, it may not be required in all embodiments. For example, a variety of hardware within calibration tone generator 410 and/or frequency response calibration unit 450 may be used to control the signal received by transmitter 430. The output of multiplexer 420 is further coupled to the input of transmitter 430. Transmitter 430 processes the input signal before it is transmitted. Processing may include changing the digital input signal to an analog signal, filtering the input signal, mixing the input signal, and amplifying the input signal. In one example, the transmitter comprises digital, analog, and RF components. As discussed above, the components used in preparation of the input signal may create distortion in the frequency response of the input signal. FIG. 5B illustrates an example frequency response for analog calibration signals at the output of the transmitter according to one embodiment of the present invention. A comparison with the calibration tones of FIG. 5A illustrates that the amplitude across portions of the frequency range have decreased due to distortion. This may lead to a non-flat frequency response across the frequency range of interest. An input signal transmitted over the air with a frequency response similar to the one shown in FIG. 5B may exhibit several potential problems including reduced SNR, therefore leading to poor transmission and possibly lost data. Calibration may help improve the quality of the transmitted signal.

Transmitter 430 is further coupled to detector 440. Detector 440 may include circuitry for detecting the amplitude or power, for example, of the signals at the output of transmitter 430, and may further generate calibration values for calibrating the channel. In one example, detector 440 extracts the amplitude from a single calibration tone. In another example, detector 440 includes additional circuitry allowing the several amplitudes to be extracted from multiple frequency components of a single signal at the output of the transmitter wherein the signal comprises multiple calibration tones sent in parallel. These detected signal characteristics may be used to generate calibration values. In one example, detector 440 transmits the detected amplitudes or powers, for example, to frequency response calibration unit 450 where calibration values may be generated. In one example, calibration values are generated within detector 440. In one example embodiment, detector 440 generates calibration values by comparing the amplitude of the calibration tone at the output of the transmitter against the amplitude of the calibration tone at the input of the transmitter. For example, the calibration values may be equal to the amplitude of the calibration tone at the input of the transmitter divided by the amplitude of the calibration tone at the output of the transmitter. In another example embodiment, the calibration values are equal to the inverse of the amplitudes of calibration tones at the output of the transmitter. FIG. 5C illustrates an example of calibration values at the output of the detector according to one embodiment of the present invention. Here, the calibration values generated in the detector and are equal to the amplitude of the calibration tone at the input of the transmitter divided by the amplitude of the calibration tone at the output of the transmitter. A comparison of FIG. 5A, FIG. 5B, and FIG. 5C illustrates that different calibration tones may be generated at different frequencies. Accordingly, calibration values may be generated at each frequency to calibrate a corresponding frequency component of a signal to be transmitted. These calibration values may be used by frequency response calibration unit 450 to calibrate an input signal.

Detector 440 is further coupled to frequency response calibration unit 450. Frequency response calibration unit 450 may preprocess the signal to be transmitted before it enters transmitter 430. This preprocess may include combining the frequency components of the received signal with the stored calibration values. For example, a signal comprising components at frequencies 4 GHz and 4.125 GHz may combine the component at 4 GHz with a calibration value generated from a calibration tone having a frequency of 4 GHz. Likewise, the component at 4.125 GHz may be combined with a calibration value generated from a calibration tone having a frequency of 4.125 GHz. This may require the calibration unit to store calibration values with frequency components corresponding to the plurality of frequency components in the signal to be transmitted. In one example, calibration unit 450 communicates with calibration tone generator 410 the frequency components of the signal to be transmitted. Calibration tones corresponding to the frequency components may be generated and then translated to calibration values stored in the calibration unit. Once calibration values are generated, the calibration unit may calibrate and transmit the signal across the transmitter. In another example, the set of frequency components in the signal to be transmitted are known by system 400. Calibration values for this set of possible frequency components may be generated before the transmitting the input signal.

The input of calibration unit 450 is coupled to the input of system 400 for receiving digital information to be transmitted, and the output is couple to an input of multiplexer 420 for transmitting the calibrated signal during normal operation. A digital input signal to be transmitted may be received by the calibration unit and calibrated with the calibration values. Once the signal has been calibrated, it may be forwarded through multiplexer 420 to transmitter 430. Due to the calibration, the analog data signal at the output of the transmitter may contain a near flat frequency response over the frequency range of interest as it is transmitted over the air by antenna 490. This may lead to advantages such as higher overall transmitted power, higher EVM, and higher SNR.

FIG. 5D illustrates an example of a digital data signal according to one embodiment of the present invention. The data signal comprises a plurality of frequency components across a frequency range, each containing the same amplitude. FIG. 5E illustrates an example of the digital data signal at the output of the frequency response calibration unit 450 according to one embodiment of the present invention. In this example, the calibration unit has modified the data signal in FIG. 5D by combining it with the calibration values in FIG. 5C. The calibrated data signal in FIG. 5E may anticipate the distortion that occurs in the transmitter. FIG. 5F illustrates an example of the frequency response of an analog signal at the output of the transmitter according to one embodiment of the present invention. The digital signal in FIG. 5E has been converted to an analog signal and processed as it travels through the transmitter. When the signal is received by the antenna, the signal may have a near flat frequency response, which may be close to the maximum power level set by regulation, for example. This may maximize the range while minimizing the distortion in the transmitted signal.

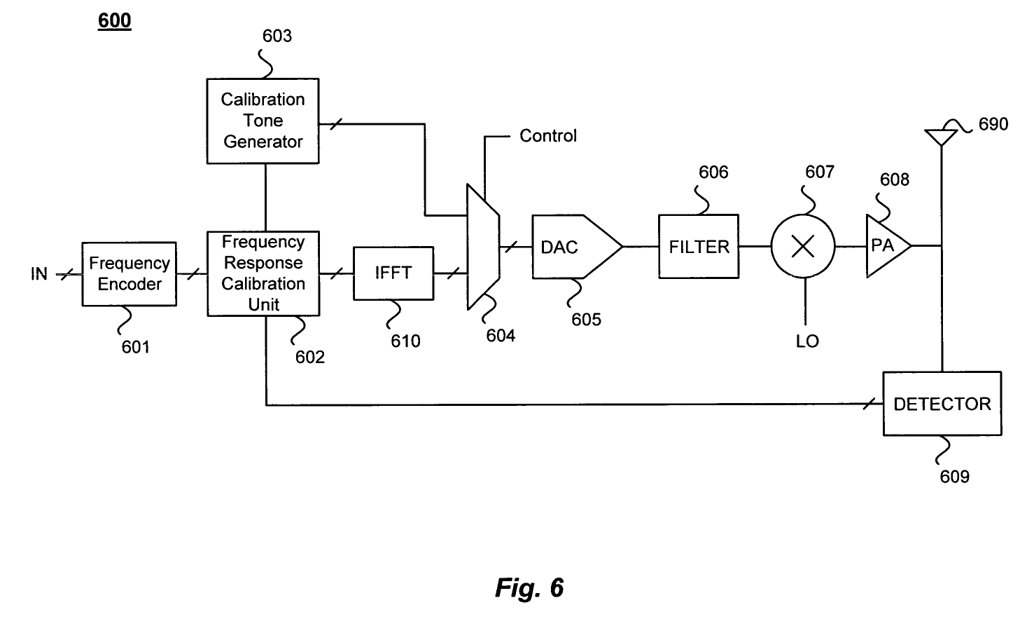

FIG. 6 illustrates a communication system according to one embodiment of the present invention. Communication system 600 comprises frequency encoder 601, frequency response calibration unit 602, calibration tone generator 603, multiplexer 604, DAC 605, filter 606, mixer 607, power amplifier 608, detector 609, inverse Fast Fourier Transform (“IFFT”) at block 610, and antenna 690. As an example this set-up can be used for communication systems based on OFDM. These components operate in two phases: a calibration phase and a transmission phase. Calibration of the transmitter begins with calibration tone generator 603 generating digital calibration tones in the time domain. The calibration tones are forwarded to the input of DAC 605 (e.g. via multiplier 604). DAC 605 may convert the calibration tones from digital to analog if the remainder of the transmitter comprises analog and RF components. DAC 605 is coupled to the input of filter 606. Filter 606 may be used to control the frequencies transmitted or to clean up the input. The output of filter 606 is coupled to the input of mixer 607, where a second local oscillator signal (“LO”) may be combined with the calibration tones. The output of mixer 607 is coupled to the input of power amplifier 608 wherein the calibration tones may be amplified for transmission. In this example, the output terminal of power amplifier 608 is further coupled to the input of detector 609 where the analog calibration tones are processed. In one embodiment, the detector may measure the amplitude of the configuration tones at the output of the transmitter and generate calibration values. However, it is to be understood that other characteristics of the calibration tones may be detected, such as power, for example. Moreover, in other embodiments, the detector may be coupled to one or more other output terminals in the transmitter to measure the frequency response. For example, the output terminal may be at the output of the DAC, filter, mixer, or power amplifier or combinations thereof. Detector 609 may detect voltage amplitude or power amplitude, for example, and may include a peak detector circuit. Detector 609 is coupled to frequency response calibration unit 602. Frequency response calibration unit may receive the processed digital calibration tones and generate calibration values if they have not been provided by detector 609. These calibration values may be stored within the calibration unit to correct the distortion in a received signal traveling through the transmitter.

Transmission of the signal may begin with frequency encoder 601 converting the digital input signal from the time domain to the frequency domain and performing other processing. The frequency encoder is coupled to the input of frequency response calibration unit 602 wherein the frequency domain digital input signal is calibrated based on the calibration values generated during the calibration phase. The output of the frequency response calibration unit is coupled to the input of IFFT 610 where the calibrated frequency domain digital input signal is converted to a time domain signal. The output of the IFFT is coupled to the input of the transmitter (e.g. via multiplexer 604) comprising DAC 605, filter 606, mixer 607, and power amplifier 608. As the calibrated input signal travels through the transmitter, it may experience distortion similar to the distortion seen by the calibration tones. If the distortion is similar, calibrating the input signal with the calibration values generated from the calibration tones may help produce a near flat frequency response at the output of the transmitter. The transmitter is coupled to the input of antenna 690. Antenna 690 may transmit an analog signal including a plurality of frequency components across a frequency range with a near flat frequency response across the range.

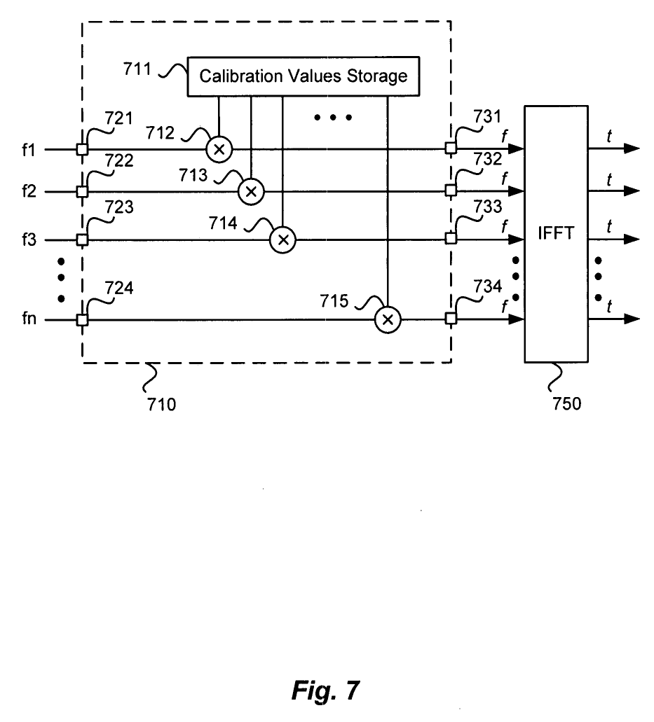

FIG. 7 illustrates a frequency response calibration unit according to one embodiment of the present invention. Frequency response calibration unit 710 receives the digital data signal in the frequency domain and calibrates it to account for the distortion that may be seen in the transmitter. In one example, an orthogonal frequency division multiplexing (“OFDM”) system calibrates the digital signal by multiplying it with calibration values. In this example embodiment, digital data in the frequency domain is received by frequency response calibration unit 710 at inputs 721 to 724. The digital data received by each input may correspond to a different frequency. For example, input 721 may transmit digital data at 4 GHz through the transmitter chain while input 722 may transmit digital data at 4.125 GHz through the transmitter chain. The digital data is first multiplied with calibration values stored in calibration value storage 711. At multiplier 712, data from input 721 is multiplied with a calibration value stored in block 711 derived from a calibration tone having the same frequency component. Similarly at 722, data from input 722 is multiplied with a calibration value stored in block 711 derived from a calibration tone having the same frequency component. This may continue until digital data from input 724 is multiplied with a corresponding calibration value derived from a calibration tone having the same frequency component stored in block 711 at multiplier 715. After calibration is performed by calibration unit 710, the calibrated digital data is passed through outputs 731 to 734 and received by the input of IFFT 750. IFFT 750 may convert the digital data from the frequency domain to the time domain for processing in the transmitter. The set-up here may be used in any system with OFDM modulations (no matter if it is employing frequency hopping or not)

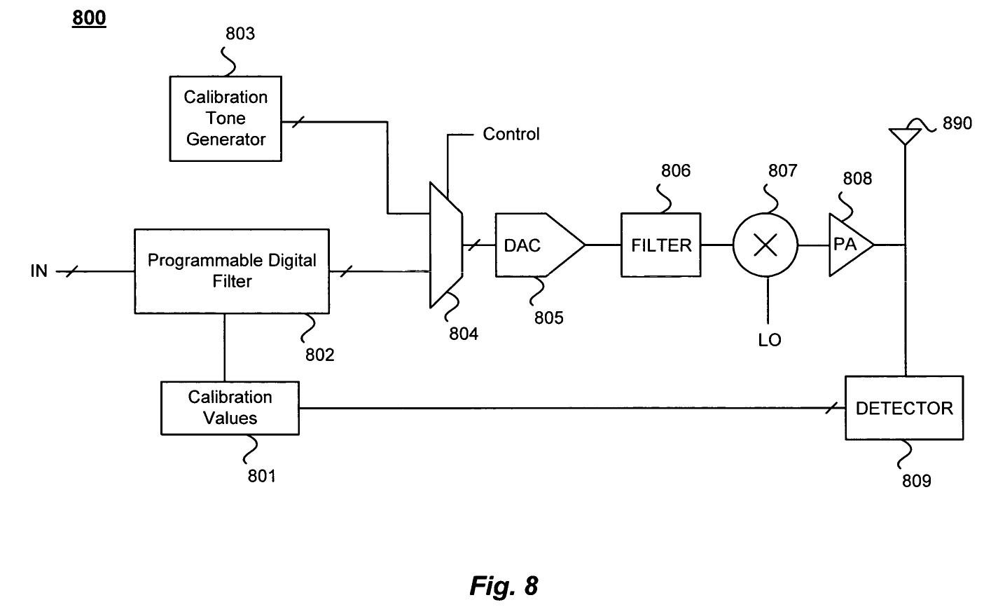

FIG. 8 illustrates a communication system using frequency response calibration unit according to another embodiment of the present invention. Communication system 800 may calibrate the signal to be transmitted in the time domain rather than the frequency domain as illustrated in communication system 600 of FIG. 6. This may be used in systems that directly send any type of QAM constellation through the channel or systems that use CDMA methods, for example. Communication system 800 includes calibration values 801, programmable digital filter 802, calibration tone generator 803, multiplexer 804, DAC 805, filter 806, mixer 807, power amplifier 808, detector 809, and antenna 890. During the calibration phase, calibration tone generator 803 may generate calibration tones. These calibration tones are detected by detector 809 and converted into calibration values, which are stored in calibration value storage 801 (e.g., a memory). During the transmission phase, a signal to be transmitted is received by programmable digital filter 802. In one embodiment, programmable digital filter 802 is a finite impulse response (“FIR”) filter. In one embodiment, the digital filter is tuned using the calibration values. For example, the gain or attenuation of the passband of the digital filter may be adjusted to compensate for corresponding attenuation or gain in the transmitter using the calibration values. In some embodiments, multiple filters may be used in parallel to adjust the frequency response of particular portions of the frequency range of the transmitter using the calibration tones, for example.

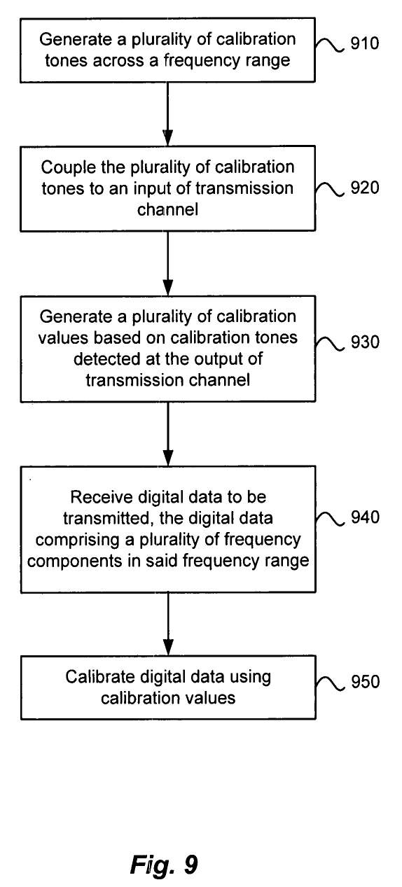

FIG. 9 illustrates a method of calibrating the frequency response of a transmitter according to one embodiment of the present invention. At 910, a plurality of calibration tones across a frequency range are generated. For example, these tones may be-generated from a calibration tone generator. In one example, the plurality of calibration tones are at the same frequencies as the plurality of frequency components in digital data to be transmitted. In one example, the plurality of calibration tones all contain the same amplitude. In one example, the plurality of calibration tones are generated serially. In another example, the plurality of calibration tones are generated in parallel. At 920, the plurality of calibration tones are coupled to an input of a transmitter. For example, the calibration tone generator may be coupled to the transmitter. In one example, the transmitter is a wireless channel. In one example, the calibration tones are digital signals and are converted to an analog signal by a digital-to-analog converter located in the transmitter. At 930, a plurality of calibration values are generated based on the calibration tones detected at the output of the transmitter. Examples of detection include detecting the voltage amplitude, power, or peak of the calibration tones at the output of the transmitter. In one example, the calibration values are generated within a detector. In one example, the calibration values are generated within a frequency response calibration unit. In one example, the calibration values are equal to the amplitude of the calibration tone at the input of the transmitter divided by the amplitude of the calibration tone at the output of the transmitter. In one example embodiment, the calibration value used to calibrate the frequency component at a given frequency is equal to the inverse of an amplitude of the calibration tone at the frequency detected at the output of the transmitter if the amplitude of the calibration tone at the frequency is equal to an amplitude of the frequency component at the frequency. At 940, digital data comprising a plurality of frequency components across the frequency range is received. The digital data may be in the time domain or the frequency domain. At 950, the digital data is calibrated using the calibration values. In one example, calibrating comprises multiplying the frequency components of the digital data by the calibration values. In one example, calibrating comprises changing the frequency response of a digital filter using the calibration values and using the digital filter on the received digital data.

The above description illustrates various embodiments of the present invention along with examples of how aspects of the present invention may be implemented. The above examples and embodiments should not be deemed to be the only embodiments, and are presented to illustrate the, flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method of calibrating the frequency response of a transmitter comprising:
generating a plurality of calibration tones across a frequency range;
coupling the plurality of calibration tones to an input of said transmitter;
detecting the plurality of calibration tones at an output terminal in said transmitter, and in accordance therewith, generating a plurality of calibration values;
receiving digital data to be transmitted, the digital data comprising a plurality of frequency components in said frequency range; and
calibrating said frequency components of said digital data using the calibration values.

2. The method of claim 1 wherein the plurality of calibration tones are at the same frequencies as the plurality of frequency components.

3. The method of claim 1 wherein the plurality of calibration tones are generated and detected serially.

4. The method of claim 1 wherein the plurality of calibration tones are generated and detected in parallel.

5. The method of claim 1 wherein calibrating said frequency components comprises multiplying the frequency components of the digital data by said calibration values.

6. The method of claim 5 further comprising converting the frequency components into a time domain digital signal.

7. The method of claim 1 wherein calibrating said frequency components comprises changing the frequency response of a digital filter using the calibration values.

8. The method of claim 7 wherein calibrating said frequency components further comprises altering the frequency response of the frequency components of said digital data with the digital filter.

9. The method of claim 1 wherein detecting comprises detecting the amplitude of the calibration tones at the output of the transmitter.

10. The method of claim 1 wherein detecting comprises detecting the power of the calibration tones at the output of the transmitter.

11. The method of claim 1 wherein the calibration tones are digital signals, and wherein the digital signals are converted to analog signal by a digital-to-analog converter.

12. The method of claim 1 wherein the calibration values are equal to the inverse of the amplitudes of the calibration tones.

13. The method of claim 1 wherein the calibration values are equal to the amplitude of the calibration tone at the input of the transmitter divided by the amplitude of the calibration tone at the output of the transmitter.

14. The method of claim 1 wherein the transmitter is a wireless transmitter.

15. The method of claim 1 wherein the transmitter comprises a DAC, a filter, a mixer, and a power amplifier, and wherein said output terminal is an output terminal of said DAC, said filter, said mixer, or said power amplifier.

16. A communication system comprising:
a calibration tone generator for generating a plurality of calibration tones across a frequency range;
a transmitter coupled to receive said calibration tones;
a detector coupled to an output in the transmitter, the detector generating a plurality of calibration values in response to the calibration tones; and
a frequency response calibration unit coupled to receive digital data to be transmitted and further coupled to receive the calibration values, the digital data comprising a plurality of frequency components in said frequency range,
wherein the frequency response calibration unit calibrates said frequency components of said digital data using the calibration values.

17. The communication system of claim 16 wherein the calibration tones are transmitted serially.

18. The communication system of claim 16 wherein the calibration tones are transmitted in parallel.

19. The communication system of claim 16 wherein the calibration tones are the same amplitude.

20. The communication system of claim 16 wherein the calibration tones and the digital data contain the same frequency components.

21. The communication system of claim 16 wherein the plurality of calibration values are the inverse of the calibration tones at the output of the transmitter.

22. The communication system of claim 16 wherein the frequency response calibration unit comprises a programmable digital filter.
